(19) United States
(12) Patent Application Publication
(10) Pub. No.: US 2020/0244664 A1
(43) Pub. Date: Jul. 30, 2020

(54) SYSTEMS AND METHODS FOR ACCESS CONTROL TO RESOURCES VIA TOKENIZATION

(71) Applicant: Johnson Controls Technology Company, Auburn Hills, MI (US)

(72) Inventors: Sachin Yashwant Pate, Mumbai (IN); Yogesh Nilkanth Jalkote, Pune (IN); Ankur Thareja, Alwar (IN); Braja Majumdar, Hooghly (IN); Rajesh Nayak, Manipal (IN)

(73) Assignee: Johnson Controls Technology Company, Auburn Hills, MI (US)

(21) Appl. No.: 16/776,227

(22) Filed: Jan. 29, 2020

Related U.S. Application Data
(60) Provisional application No. 62/798,989, filed on Jan. 30, 2019.

(51) Int. Cl. H04L 29/06

(52) U.S. Cl. CPC H04L 63/102; H04L 63/108; H04L 63/083

(57) ABSTRACT

A system includes a communications interface communicably coupled to a computing environment and a client device corresponding to a first tenant of a plurality of tenants of the computing environment. The computing environment includes a plurality of resources, at least one resource being accessible by the client device, and a processing circuit including a processor and memory, the memory storing instructions that, when executed by the processor, cause the processor to perform operations including generating a multi-organization token for the at least one resource based on credentials corresponding to the first tenant, receiving a request to access the at least one resource in the computing environment, the request including the first tenant-specific token, determining whether the first tenant-specific token is valid, and providing access to the at least one resource in the computing environment responsive to a determination that the first tenant-specific token is valid.

### CROSS-REFERENCE TO RELATED PATENT APPLICATIONS

The present application claims priority to and the benefit of U.S. Provisional Application No. 62/798,989, filed Jan. 30, 2019, which is incorporated herein by reference in its entirety.

### BACKGROUND

The present disclosure relates generally to identity management systems. More specifically, the present disclosure relates to enterprise identity management systems which regulate access to resources.

Various computing environments, such as servers, databases, etc., may host resources. Some resources may include, for instance, applications. Such applications (and other resources) may be accessible by various enterprises (e.g., client devices for the enterprise). For instance, a given enterprise may subscribe to access particular resources. Hence, various enterprises may subscribe to access different resources. Some resources may schedule jobs for each of the subscribed enterprises or tenants. However, some tenants may no longer be “active,” which could result in wasted time and computing power.

Some identity management systems may determine the identity of individuals. The identity management systems may determine the identity based on, for instance, credentials provided by such individuals. Some examples of credentials may include, for instance, usernames and passwords, personal identification numbers (PINs), biometric information, etc. However, some credentials may be inadvertently or purposefully shared to other individuals, which could compromise security.

### SUMMARY

One implementation of the present disclosure is a system for providing access to enterprise-specific resources. The system includes a communications interface communicably coupled to a computing environment and a client device corresponding to a first tenant of a plurality of tenants of the computing environment, the computing environment including a plurality of resources, at least one resource being accessible by the client device, and a processing circuit including a processor and memory, the memory storing instructions that, when executed by the processor, cause the processor to perform operations. The operations include generating a multi-organization token for the at least one resource based on credentials corresponding to the first tenant, receiving, from the client device, a request to access the at least one resource in the computing environment, the request including the first tenant-specific token, determining whether the first tenant-specific token is valid, and providing access to the at least one resource in the computing environment responsive to a determination that the first tenant-specific token is valid based on the indication that the first tenant-specific token is included in the multi-organization token.

In some embodiments, the multi-organization token is a resource-specific token associated with the at least one resource, and the multi-organization token further includes a first tenant-specific token associated with the first tenant and a second tenant-specific token associated with a second tenant of the plurality of tenants. In some embodiments, a determination that the first tenant-specific token is included in the multi-organization token indicates that the first tenant-specific token is valid, and the determination that the first tenant-specific token is valid further indicates that the client device is permitted to access the at least one resource in the computing environment.

In some embodiments, the at least one resource includes data corresponding to at least one of faults of one or more components of a building, consumption corresponding to the one or more components of the building, or efficiency corresponding to the one or more components of the building.

In some embodiments, the system further includes generating the first tenant-specific token and the second tenant-specific token responsive to receiving the request to access the at least one resource.

In some embodiments, the request to access the at least one resource is a request to access the computing environment to provision a plurality of scheduled jobs for the one or more tenants having access to the computing environment.

In some embodiments, access is provided to the at least one resource to run the plurality of scheduled jobs.

In some embodiments, the request includes an organization identifier.

In some embodiments, the operations further include determining, based on the organization identifier, which of the plurality of resources the client device is permitted to access. In some embodiments, access is provided to the at least one resource responsive to determining the client device is permitted to access the at least one resource.

In some embodiments, the request is submitted on behalf of a user of the first tenant, wherein the tenant-specific token is a time-bound token which provides the client device access to the at least one resource which the user is permitted to access for a limited duration.

Another implementation of the present disclosure is a method for providing access to enterprise-specific resources. The method includes generating, by a processing circuit, a resource-specific token based on credentials corresponding to a first tenant of a plurality of tenants, the resource-specific token associated with a first resource of a plurality of resources in a computing environment, the resource-specific token including a plurality of tenant-specific tokens including a first token for the first tenant and a second token for a second tenant, receiving, by the processing circuit, from a client device corresponding to the first tenant, a request to access the first resource, the request including the first token, determining, by the processing circuit, whether the first token is valid, and providing, by the processing circuit, access to the first resource in the computing environment responsive to a determination that the first token is valid.

In some embodiments, a determination that the first token is valid is based on an indication that the first token is included in the resource-specific token, and the determination that the first token is valid further indicates that the first token is permitted to access the first resource,

In some embodiments, the method further includes generating the first token and the second token responsive to receiving the request to access the first resource.

In some embodiments, the request to access the first resource is a request to access the computing environment to provision a plurality of scheduled jobs for the plurality of tenants.

In some embodiments, providing, by the processing circuit, the access comprises providing, by the processing circuit, access to the first resource responsive to validating the first token to run the plurality of scheduled jobs.

In some embodiments, the request includes an organization identifier.

In some embodiments, the method further includes determining, by the processing circuit, based on the organization identifier, which of the plurality of resources the client device is permitted to access. In some embodiments, providing, by the processing circuit, access to the resources comprises providing, by the processing circuit, access to the resource responsive to determining the first resource is one of the plurality of resources the client device is permitted to access.

In some embodiments, the request is submitted on behalf of the first tenant, wherein the first token is a time-bound token which provides the client device access to a subset of the plurality of resources which the first tenant is permitted to access for a limited duration.

Another implementation of the present disclosure includes a building system for providing access to enterprise-specific resources. The system includes one or more memory devices configured to store instructions thereon, that, when executed by one or more processors, cause the one or more processors to perform operations. The operations include generating a token for each of a plurality of tenants, wherein each token indicates which resources of a plurality of resources in a computing environment a corresponding tenant is permitted to access, transmitting the tokens to a plurality of client devices associated with the plurality of tenants, receiving, from a client device corresponding to a first tenant, a request to access one of the plurality of resources, the request including credentials for accessing the computing environment and a token corresponding to the first tenant, determining, based on the credentials, a subset of the plurality of resources the first tenant is permitted to access within the computing environment, validating the token based on the credentials, and providing access to the subset of resources in the computing environment responsive to validating the token

In some embodiments, the request is submitted on behalf of a user of the tenant, and wherein a first token of the tokens for each of a plurality of tenants is a time-bound token.

In some embodiments, providing access to the subset of resources comprises providing, to the client device, read-only access to the subset of resources on behalf of the client for a limited duration of time in accordance with the time-bound token.

In some embodiments, the request is a request to access the computing environment to provision a plurality of scheduled jobs for one or more of the plurality of tenants having access to the computing environment.

In some embodiments, providing access comprises providing access to the subset of resources responsive to validating the token to run the plurality of scheduled jobs.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

FIG. 1 is a drawing of a building equipped with a heating, ventilating, or air conditioning (HVAC) system and a building management system (BMS), according to an illustrative embodiment.

FIG. 2 is a schematic diagram of a waterside system which may be used to support the HVAC system of FIG. 1, according to an illustrative embodiment.

FIG. 3 is a block diagram of an airside system which may be used as part of the HVAC system of FIG. 1, according to an illustrative embodiment.

FIG. 4 is a block diagram of a BMS which may be implemented in the building of FIG. 1, according to an illustrative embodiment.

FIG. 5 is a block diagram of a computing environment within which aspects of the present disclosure may be implemented.

FIG. 6 is a block diagram of a system for access management to resources in the computing environment of FIG. 5, according to an illustrative embodiment.

FIG. 7 is a flowchart showing a method for access management to resources in the computing environment of FIG. 5, according to an illustrative embodiment.

### DETAILED DESCRIPTION

Referring generally to the FIGURES, depicted are systems and methods for providing access control to resources via tokenization. The systems and methods described herein may be used to access resources corresponding to a building or enterprise.

An enterprise identity management system (EIMS) generates a resource-specific token based on credentials corresponding to a tenant. The resource-specific tokens include a plurality of tenant-specific tokens including a token for the tenant. The EIMS receives a request from a client device to access a resource in a computing environment. The request includes the token. The EIMS determines, based on the token, that the token is valid and the client device is permitted to access the resource in the computing environment. The EIMS provides access to the resource in the computing environment.

According to the embodiments described herein, the EIMS provides seamless access to resources—particularly those corresponding to an enterprise. The EIMS increases security of usernames and passwords for resources by limiting sharing of such information. Rather, the embodiments described herein provides for access via tokenization—thereby limiting the likelihood of usernames and passwords being shared by different entities. Various other benefits of the present disclosure will become apparent as follows.

### Building Management System and HVAC System

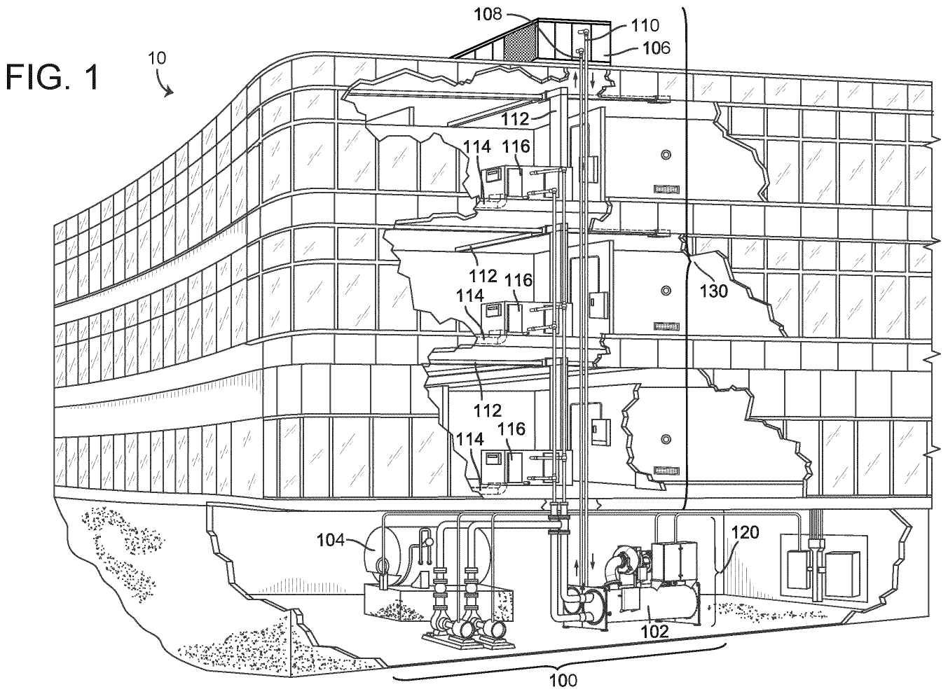

Referring now to FIGS. 1-4, an illustrative building management system (BMS) and HVAC system in which the systems and methods of the present disclosure may be implemented are shown, according to an illustrative embodiment. Referring particularly to FIG. 1, a perspective view of a building 10 is shown. Building 10 is served by a BMS. A BMS is, in general, a system of devices configured to control, monitor, and manage equipment in or around a building or building area. A BMS may include, for example, an HVAC system, a security system, a lighting system, a fire alerting system, any other system that is capable of managing building functions or devices, or any combination thereof.

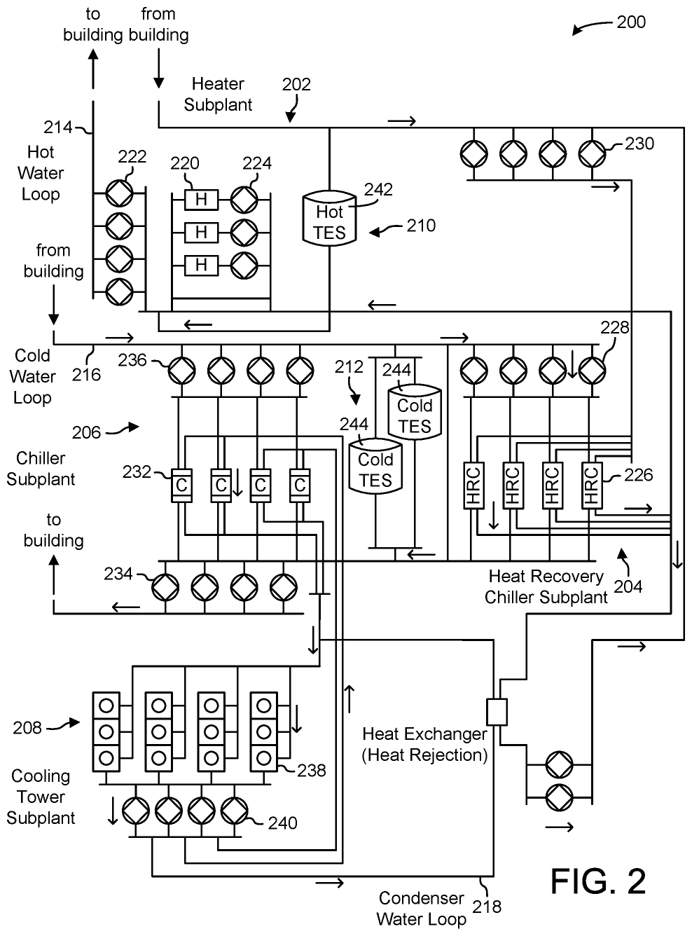

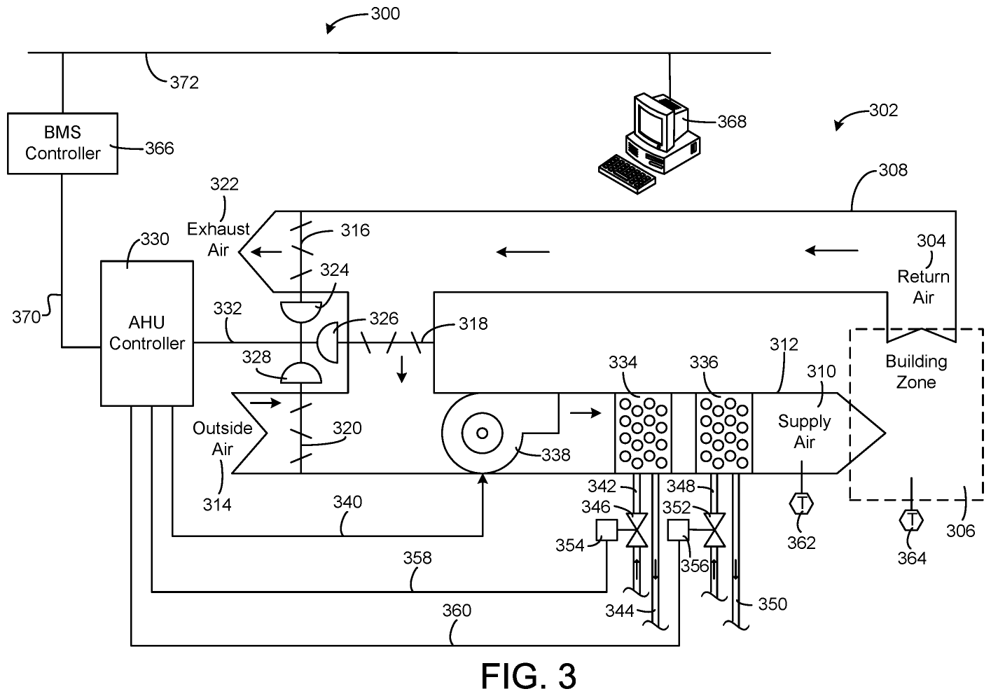

The BMS that serves building 10 includes an HVAC system 100. HVAC system 100 may include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 may provide heated or chilled fluid to an air handling unit of airside system 130. Airside system 130 may use the heated or chilled fluid to heat or cool an airflow provided to building 10. An illustrative waterside system and airside system which may be used in HVAC system 100 are described in greater detail with reference to FIGS. 2-3.

HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 may be located in or around building 10 (as shown in FIG. 1) or at an offsite location such as a central plant (e.g., a chiller plant, a steam plant, a heat plant, etc.). The working fluid may be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 may be transported to AHU 106 via piping 108.

AHU 106 may place the working fluid in a heat exchange relationship with an airflow passing through AHU 106 (e.g., via one or more stages of cooling coils and/or heating coils). The airflow may be, for example, outside air, return air from within building 10, or a combination of both. AHU 106 may transfer heat between the airflow and the working fluid to provide heating or cooling for the airflow. For example, AHU 106 may include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 may include dampers or other flow control elements that may be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 may include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve set point conditions for the building zone.

Referring now to FIG. 2, a block diagram of a waterside system 200 is shown, according to an illustrative embodiment. In various embodiments, waterside system 200 may supplement or replace waterside system 120 in HVAC system 100 or may be implemented separate from HVAC system 100. When implemented in HVAC system 100, waterside system 200 may include a subset of the HVAC devices in HVAC system 100 (e.g., boiler 104, chiller 102, pumps, valves, etc.) and may operate to supply a heated or chilled fluid to AHU 106. The HVAC devices of waterside system 200 may be located within building 10 (e.g., as components of waterside system 120) or at an offsite location such as a central plant.

In FIG. 2, waterside system 200 is shown as a central plant having a plurality of subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve the thermal energy loads (e.g., hot water, cold water, heating, cooling, etc.) of a building or campus. For example, heater subplant 202 may be configured to heat water in a hot water loop 214 that circulates the hot water between heater subplant 202 and building 10. Chiller subplant 206 may be configured to chill water in a cold water loop 216 that circulates the cold water between chiller subplant 206 and building 10. Heat recovery chiller subplant 204 may be configured to transfer heat from cold water loop 216 to hot water loop 214 to provide additional heating for the hot water and additional cooling for the cold water. Condenser water loop 218 may absorb heat from the cold water in chiller subplant 206 and reject the absorbed heat in cooling tower subplant 208 or transfer the absorbed heat to hot water loop 214. Hot TES subplant 210 and cold TES subplant 212 may store hot and cold thermal energy, respectively, for subsequent use.

Hot water loop 214 and cold water loop 216 may deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air may be delivered to individual zones of building 10 to serve the thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) may be used in place of or in addition to water to serve the thermal energy loads. In other embodiments, subplants 202-212 may provide heating and/or cooling directly to the building or campus without requiring an intermediate heat transfer fluid. These and other variations to waterside system 200 are within the teachings of the present disclosure.

Each of subplants 202-212 may include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 may also include one or more pumps or valves configured to control the flow rate of the hot water into or out of hot TES tank 242. Cold TES subplant 212 is shown to include cold TES tanks 244 configured to store the cold water for later use. Cold TES subplant 212 may also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves may be integrated with the pumps or positioned upstream or downstream of the pumps to control the fluid flows in waterside system 200. In various embodiments, waterside system 200 may include more, fewer, or different types of devices and/or subplants based on the particular configuration of waterside system 200 and the types of loads served by waterside system 200.

Referring now to FIG. 3, a block diagram of an airside system 300 is shown, according to an illustrative embodiment. In various embodiments, airside system 300 may supplement or replace airside system 130 in HVAC system 100 or may be implemented separate from HVAC system 100. When implemented in HVAC system 100, airside system 300 may include a subset of the HVAC devices in HVAC system 100 (e.g., AHU 106, VAV units 116, ducts 112-114, fans, dampers, etc.) and may be located in or around building 10. Airside system 300 may operate to heat or cool an airflow provided to building 10 using a heated or chilled fluid provided by waterside system 200.

In FIG. 3, airside system 300 is shown to include an economizer-type AHU 302. Economizer-type AHUs vary the amount of outside air and return air used by the air handling unit for heating or cooling. For example, AHU 302 may receive return air 304 from building zone 306 via return air duct 308 and may deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 may be configured to operate exhaust air damper 316, mixing damper 318, and outside air damper 320 to control an amount of outside air 314 and return air 304 that combine to form supply air 310. Any return air 304 that does not pass through mixing damper 318 may be exhausted from AHU 302 through exhaust damper 316 as exhaust air 322.

Each of dampers 316-320 may be operated by an actuator. For example, exhaust air damper 316 may be operated by actuator 324, mixing damper 318 may be operated by actuator 326, and outside air damper 320 may be operated by actuator 328. Actuators 324-328 may communicate with an AHU controller 330 via a communications link 332. Actuators 324-328 may receive control signals from AHU controller 330 and may provide feedback signals to AHU controller 330. Feedback signals may include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that may be collected, stored, or used by actuators 324-328. AHU controller 330 may be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 may be configured to force supply air 310 through cooling coil 334 and/or heating coil 336 and provide supply air 310 to building zone 306. AHU controller 330 may communicate with fan 338 via communications link 340 to control a flow rate of supply air 310. In some embodiments, AHU controller 330 controls an amount of heating or cooling applied to supply air 310 by modulating a speed of fan 338.

Cooling coil 334 may receive a chilled fluid from waterside system 200 (e.g., from cold water loop 216) via piping 342 and may return the chilled fluid to waterside system 200 via piping 344. Valve 346 may be positioned along piping 342 or piping 344 to control a flow rate of the chilled fluid through cooling coil 334. In some embodiments, cooling coil 334 includes multiple stages of cooling coils that may be independently activated and deactivated (e.g., by AHU controller 330, by BMS controller 366, etc.) to modulate an amount of cooling applied to supply air 310.

Heating coil 336 may receive a heated fluid from waterside system 200 (e.g., from hot water loop 214) via piping 348 and may return the heated fluid to waterside system 200 via piping 350. Valve 352 may be positioned along piping 348 or piping 350 to control a flow rate of the heated fluid through heating coil 336. In some embodiments, heating coil 336 includes multiple stages of heating coils that may be independently activated and deactivated (e.g., by AHU controller 330, by BMS controller 366, etc.) to modulate an amount of heating applied to supply air 310.

Each of valves 346 and 352 may be controlled by an actuator. For example, valve 346 may be controlled by actuator 354 and valve 352 may be controlled by actuator 356. Actuators 354-356 may communicate with AHU controller 330 via communications links 358-360. Actuators 354-356 may receive control signals from AHU controller 330 and may provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 may also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU controller 330 may control the temperature of supply air 310 and/or building zone 306 by activating or deactivating coils 334-336, adjusting a speed of fan 338, or a combination of both.

Still referring to FIG. 3, airside system 300 is shown to include a BMS controller 366 and a client device 368. BMS controller 366 may include one or more computer systems (e.g., servers, supervisory controllers, subsystem controllers, etc.) that serve as system-level controllers, application or data servers, head nodes, or master controllers for airside system 300, waterside system 200, HVAC system 100, and/or other controllable systems that serve building 10. BMS controller 366 may communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BMS controller 366 may be separate (as shown in FIG. 3) or integrated. In an integrated implementation, AHU controller 330 may be a software module configured for execution by a processor of BMS controller 366.

In some embodiments, AHU controller 330 receives information from BMS controller 366 (e.g., commands, setpoints, operating boundaries, etc.) and provides information to BMS controller 366 (e.g., temperature measurements, valve or actuator positions, operating statuses, diagnostics, etc.). For example, AHU controller 330 may provide BMS controller 366 with temperature measurements from temperature sensors 362-364, equipment on/off states, equipment operating capacities, and/or any other information that may be used by BMS controller 366 to monitor or control a variable state or condition within building zone 306.

Client device 368 may include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 may be a computer workstation, a client terminal, a remote or local interface, or any other type of user interface device. Client device 368 may be a stationary terminal or a mobile device. For example, client device 368 may be a desktop computer, a computer server with a user interface, a laptop computer, a tablet, a smartphone, a PDA, or any other type of mobile or non-mobile device. Client device 368 may communicate with BMS controller 366 and/or AHU controller 330 via communications link 372.

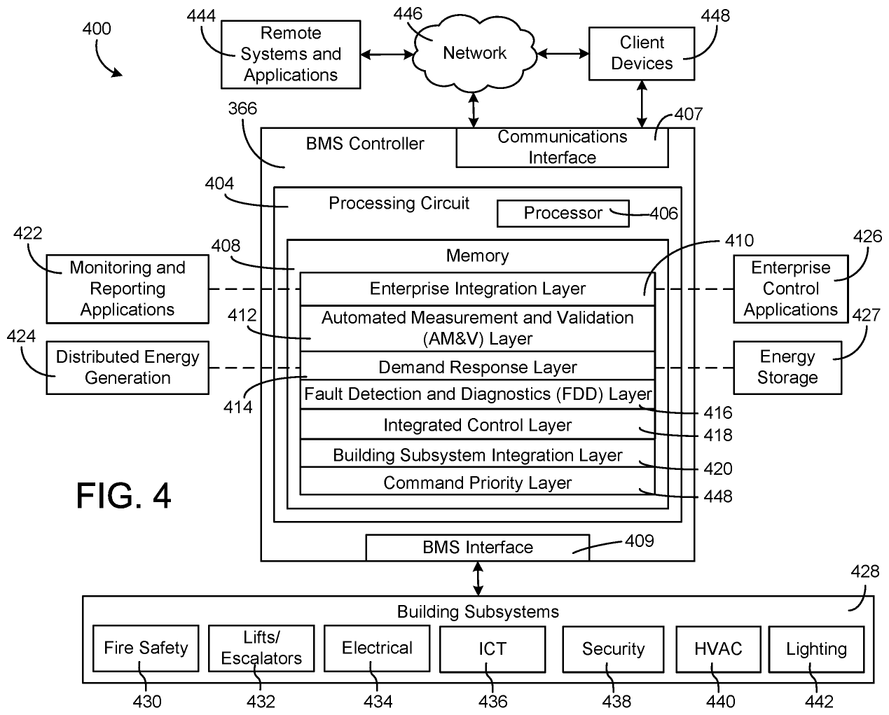

Referring now to FIG. 4, a block diagram of a BMS 400 is shown, according to an illustrative embodiment. BMS 400 may be implemented in building 10 to automatically monitor and control various building functions. BMS 400 is shown to include BMS controller 366 and a plurality of building subsystems 428. Building subsystems 428 are shown to include a building electrical subsystem 434, an information communication technology (ICT) subsystem 436, a security subsystem 438, an HVAC subsystem 440, a lighting subsystem 442, a lift/escalators subsystem 432, and a fire safety subsystem 430. In various embodiments, building subsystems 428 may include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include waterside system 200 and/or airside system 300, as described with reference to FIGS. 2-3.

Each of building subsystems 428 may include any number of devices, controllers, and connections for completing its individual functions and control activities. HVAC subsystem 440 may include many of the same components as HVAC system 100, as described with reference to FIGS. 1-3. For example, HVAC subsystem 440 may include any number of chillers, heaters, handling units, economizers, field controllers, supervisory controllers, actuators, temperature sensors, and/or other devices for controlling the temperature, humidity, airflow, or other variable conditions within building 10. Lighting subsystem 442 may include any number of light fixtures, ballasts, lighting sensors, dimmers, or other devices configured to controllably adjust the amount of light provided to a building space. Security subsystem 438 may include occupancy sensors, video surveillance cameras, digital video recorders, video processing servers, intrusion detection devices, access control devices and servers, or other security-related devices.

Still referring to FIG. 4, BMS controller 366 is shown to include a communications interface 407 and a BMS interface 409. Interface 407 may facilitate communications between BMS controller 366 and external applications (e.g., monitoring and reporting applications 422, enterprise control applications 426, remote systems and applications 444, applications residing on client devices 448, etc.) for allowing user control, monitoring, and adjustment to BMS controller 366 and/or subsystems 428. Interface 407 may also facilitate communications between BMS controller 366 and client devices 448. BMS interface 409 may facilitate communications between BMS controller 366 and building subsystems 428 (e.g., HVAC, lighting security, lifts, power distribution, business, etc.).

Interfaces 407 and 409 may be or may include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407 and 409 may be direct (e.g., local wired or wireless communications) or via a communications network 446 (e.g., a WAN, the Internet, a cellular network, etc.). For example, interfaces 407 and 409 may include an Ethernet card and port for sending and receiving data via an Ethernet-based communications link or network. In another example, interfaces 407 and 409 may include a WiFi transceiver for communicating via a wireless communications network. In another example, one or both of interfaces 407 and 409 may include cellular or mobile phone communications transceivers. In one embodiment, communications interface 407 is a power line communications interface and BMS interface 409 is an Ethernet interface. In other embodiments, both communications interface 407 and BMS interface 409 are Ethernet interfaces or are the same Ethernet interface.

Still referring to FIG. 4, BMS controller 366 is shown to include a processing circuit 404 including a processor 406 and memory 408. Processing circuit 404 may be communicably connected to BMS interface 409 and/or communications interface 407 such that processing circuit 404 and the various components thereof may send and receive data via interfaces 407 and 409. Processor 406 may be implemented as a general purpose processor, an application specific integrated circuit (ASIC), one or more field programmable gate arrays (FPGAs), a group of processing components, or other suitable electronic processing components.

Memory 408 (e.g., memory, memory unit, storage device, etc.) may include one or more devices (e.g., RAM, ROM, Flash memory, hard disk storage, etc.) for storing data and/or computer code for completing or facilitating the various processes, layers, and modules described in the present application. Memory 408 may be or include volatile memory or non-volatile memory. Memory 408 may include database components, object code components, script components, or any other type of information structure for supporting the various activities and information structures described in the present application. According to an illustrative embodiment, memory 408 is communicably connected to processor 406 via processing circuit 404 and includes computer code for executing (e.g., by processing circuit 404 and/or processor 406) one or more processes described herein.

In some embodiments, BMS controller 366 is implemented within a single computer (e.g., one server, one housing, etc.). In various other embodiments, BMS controller 366 may be distributed across multiple servers or computers (e.g., that may exist in distributed locations). Further, while FIG. 4 shows applications 422 and 426 as existing outside of BMS controller 366, in some embodiments, applications 422 and 426 may be hosted within BMS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 may be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 400.

Enterprise integration layer 410 may be configured to serve clients or local applications with information and services to support a variety of enterprise-level applications. For example, enterprise control applications 426 may be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BMS controller 366. In yet other embodiments, enterprise control applications 426 may work with layers 410-420 to optimize building performance (e.g., efficiency, energy use, comfort, or safety) based on inputs received at interface 407 and/or BMS interface 409.

Building subsystem integration layer 420 may be configured to manage communications between BMS controller 366 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translates communications (e.g., sensor data, input signals, output signals, etc.) across a plurality of multi-vendor/multi-protocol systems.

Demand response layer 414 may be configured to optimize resource usage (e.g., electricity use, natural gas use, water use, etc.) and/or the monetary cost of such resource usage in response to satisfy the demand of building 10. The optimization may be based on time-of-use prices, curtailment signals, energy availability, or other data received from utility providers, distributed energy generation systems 424, from energy storage 427 (e.g., hot TES 242, cold TES 244, etc.), or from other sources. Demand response layer 414 may receive inputs from other layers of BMS controller 366 (e.g., building subsystem integration layer 420, integrated control layer 418, etc.). The inputs received from other layers may include environmental or sensor inputs such as temperature, carbon dioxide levels, relative humidity levels, air quality sensor outputs, occupancy sensor outputs, room schedules, and the like. The inputs may also include inputs such as electrical use (e.g., expressed in kWh), thermal load measurements, pricing information, projected pricing, smoothed pricing, curtailment signals from utilities, and the like.

According to an illustrative embodiment, demand response layer 414 includes control logic for responding to the data and signals it receives. These responses may include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models may include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML files, etc.). The policy definitions may be edited or adjusted by a user (e.g., via a graphical user interface) so that the control actions initiated in response to demand inputs may be tailored for the user's application, desired comfort level, particular building equipment, or based on other concerns. For example, the demand response policy definitions may specify which equipment may be turned on or off in response to particular demand inputs, how long a system or piece of equipment should be turned off, what setpoints may be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 may be configured to use the data input or output of building subsystem integration layer 420 and/or demand response later 414 to make control decisions. Due to the subsystem integration provided by building subsystem integration layer 420, integrated control layer 418 may integrate control activities of the subsystems 428 such that the subsystems 428 behave as a single integrated supersystem. In an illustrative embodiment, integrated control layer 418 includes control logic that uses inputs and outputs from a plurality of building subsystems to provide greater comfort and energy savings relative to the comfort and energy savings that separate subsystems could provide alone. For example, integrated control layer 418 may be configured to use an input from a first subsystem to make an energy-saving control decision for a second subsystem. Results of these decisions may be communicated back to building subsystem integration layer 420.

Integrated control layer 418 is shown to be logically below demand response layer 414. Integrated control layer 418 may be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 may be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 may be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and AM&V layer 412. Integrated control layer 418 may be configured to provide calculated inputs (e.g., aggregations) to these higher levels based on outputs from more than one building subsystem.

AM&V layer 412 may be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 may be based on building system energy models and/or equipment models for individual BMS devices or subsystems. For example, AM&V layer 412 may compare a model-predicted output with an actual output from building subsystems 428 to determine an accuracy of the model.

FDD layer 416 may be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, or from another data source. FDD layer 416 may automatically diagnose and respond to detected faults. The responses to detected or diagnosed faults may include providing an alert message to a user, a maintenance scheduling system, or a control algorithm configured to attempt to repair the fault or to work-around the fault.

FDD layer 416 may be configured to output a specific identification of the faulty component or cause of the fault (e.g., loose damper linkage) using detailed subsystem inputs available at building subsystem integration layer 420. In other illustrative embodiments, FDD layer 416 is configured to provide “fault” events to integrated control layer 418 which executes control strategies and policies in response to the received fault events. According to an illustrative embodiment, FDD layer 416 (or a policy executed by an integrated control engine or business rules engine) may shut-down systems or direct control activities around faulty devices or systems to reduce energy waste, extend equipment life, or assure proper control response.

FDD layer 416 may be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BMS 400 and the various components thereof. The data generated by building subsystems 428 may include measured or calculated values that exhibit statistical characteristics and provide information about how the corresponding system or process (e.g., a temperature control process, a flow control process, etc.) is performing in terms of error from its setpoint. These processes may be examined by FDD layer 416 to expose when the system begins to degrade in performance and alert a user to repair the fault before it becomes more severe.

### Computing Environment

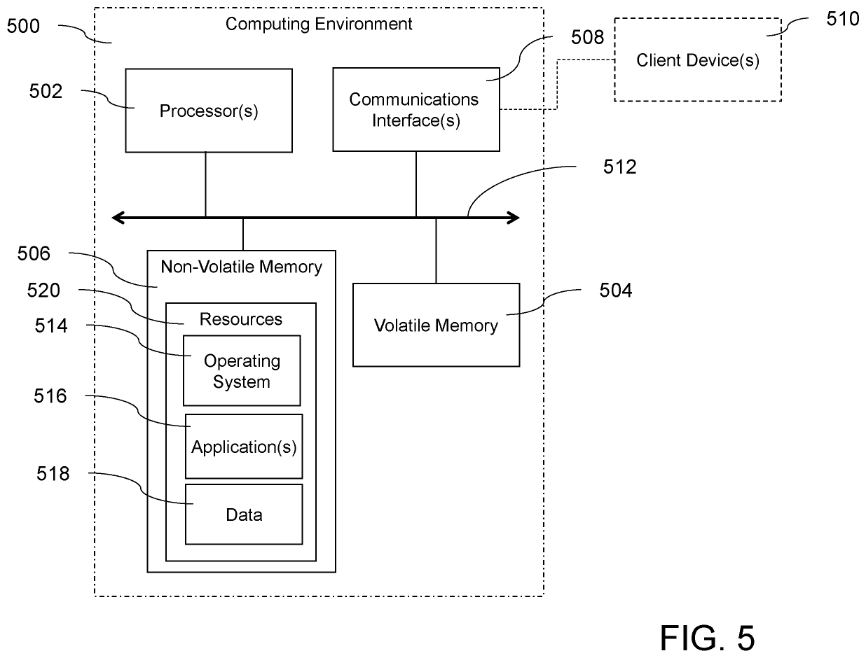

Referring now to FIG. 5, a computing environment 500 is shown within which some of the aspects of the present disclosure may be implemented. For instance, the BMS controller 366 may be implemented within or include various components depicted in FIG. 5. Similarly, various applications, sites, resources, etc. shown in FIG. 5 may use data and feedback from the BMS controller 366.

As shown in FIG. 5, the computing environment 500 may include one or more processors 502, volatile memory 504 (e.g., random access memory (RAM)), non-volatile memory 506 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof) and one or more communications interfaces 508. Various client devices 510 (e.g., mobile devices, desktops, laptops, tablets, or other computing devices) may be configured to access the components included in the computing environment 500 via the communications interface 508 and through communication bus 512.

Non-volatile memory 506 stores operating system 514, one or more applications 516, and data 518 (collectively referred to as resources 520) such that, for example, computer instructions of operating system 514 and/or applications 516 are executed by processor(s) 502 out of volatile memory 504. In some embodiments, volatile memory 504 may include one or more types of RAM and/or a cache memory that may offer a faster response time than a main memory. Various elements of computing environment 500 may communicate via one or more communication buses, shown as communication bus 512.

The computing environment 500 (and client device 510) are shown merely as an example. Such components may be implemented as client devices, servers, networking devices etc., and may be implemented by any computing or processing environment and with any type of machine or set of machines that may have suitable hardware and/or software capable of operating as described herein. Processor(s) 502 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A “processor” may perform the function, operation, or sequence of operations using digital values and/or using analog signals. In some embodiments, the “processor” can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors. A processor including multiple processor cores and/or multiple processors multiple processors may provide functionality for parallel, simultaneous execution of instructions or for parallel, simultaneous execution of one instruction on more than one piece of data. In various embodiments, the components in the computing environment 500 may collectively be implemented within a server (or group of servers).

In various embodiments, one or more client devices 510 may be configured to access, for instance, applications 516 in the non-volatile memory 506 of the computing environment 500. Some of the applications 516 may be applications corresponding to the BMS shown and described above. Other applications 516 may correspond to general enterprise or building management systems. For instance, some applications 516 may correspond to human resources, and other applications 516 may correspond to the HVAC system 100. In various embodiments, at least one of the applications 516 may include or provide data (e.g., to a client device 510) corresponding to various aspects of the building 10. The application 516 may include or provide data corresponding to faults of various components of a building 10, consumption, efficiency, etc. corresponding to the components (e.g., separately or grouped together within various building subsystems) for the building 10. The client device 510 may be associated with a respective tenant (e.g., an enterprise), and the tenant may include (e.g., own or operate) various buildings 10. The applications 516 may include or provide such data corresponding to a plurality of tenants (including the tenant associated with a particular client device 510). The client devices 510, however, may be limited to accessing resources 520 corresponding to their respective tenant.

The client device 510 may be configured to access the applications 516 by providing token(s) as log-in credentials, as described in greater detail below. The client device(s) 510 may access the resources 520 within the computing environment 500 via a respective communications interface through communications interfaces 508. Communications interfaces 508 may include one or more interfaces to enable the client device(s) 510 to access a computer network, such as a Local Area Network (LAN), a Wide Area Network (WAN), a Personal Area Network (PAN), or the Internet through a variety of wired and/or wireless or cellular connections, upon which the resources 520 are available to the client device(s) 510.

### Systems and Methods for Providing Access to Enterprise Resources

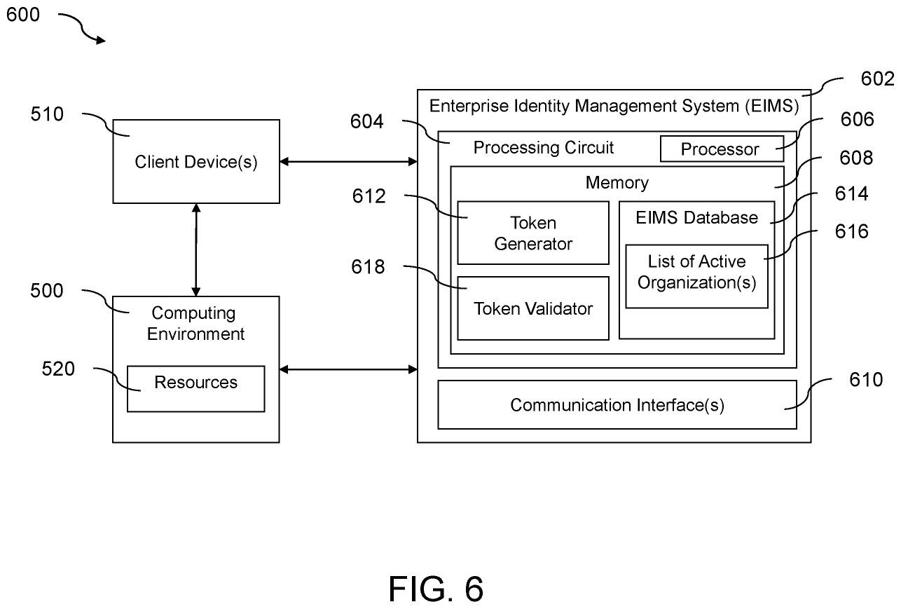

Referring to FIG. 6, a block diagram of a system 600 is shown for providing access to enterprise-specific resources, according to an exemplary embodiment. The system 600 may provide access to the resources 520 in the computing environment 500 depicted in FIG. 5. The system 600 is shown to include an enterprise identity management system (EIMS) 602, a client device 510, and a computing environment 500. The client device 510 and computing environment 500 may include aspects similar to those described above with reference to FIG. 5. As described in greater detail below, the EIMS 602 may be configured to generate token(s) for various client devices 510 to access resources 520 within the computing environment 500. The EIMS 602 may be configured to subsequently validate token(s) received by the computing environment 500 from the client device(s) 510. The EIMS 602 may be configured to provide the client device(s) 510 access to various resource(s) 520 responsive to validating the token, as described in greater detail below.

EIMS 602 may generally be designed or implemented to manage individual identities, their authentication, authorization, roles and privileges within or across system and enterprise boundaries and in various environments (including, for instance, the computing environment 500). EIMS 602 may include various components or features which limit access to specific applications, systems, components, data, environments, or other resources to authorized, authenticated users. EIMS 602 may include various components for onboarding new users, access control of existing users, and offboarding of users who are no longer authorized access some or all resources. In some embodiments, EIMS 602 may be incorporated into or a component or aspect of various human resources computing environments. Thus, EIMS 602 may be an important aspect of an enterprise security and productivity plan for employees or other personnel who may have access to resources within the enterprise.

In various embodiments, EIMS 602 may be deployed on a dedicated computing device (such as a dedicated server or network appliance). The dedicated computing device may be located on-premises (e.g., within a corresponding building for the enterprise), or EIMS 602 may be deployed in the cloud. EIMS 602 may apply various policies or protocols which define which client device 510 (and corresponding users) are permitted to access specific resources, and what permissions such users may have with respect to those resources. The embodiments described herein may be used for managing access to enterprise resources, while managing customer, partner, supplier and device access to its systems and ensuring security is a priority for the enterprise.

Some embodiments and deployments of EIMS 602 may include features for management of individual identities, their authentication, authorization, roles and/or privileges within or across system and enterprise boundaries (also referred to herein as access control). However, such EIMS 602 may not provide for multi-organization token generation, in some embodiments. In some embodiments, multi-organization token generation and/or access control may be performed by separate entities. Furthermore, device registration and management and access control may be performed by separate entities (which may even occur on a resource-by-resource basis). Since these systems work independently of one another and there is no direct integration, such systems collectively may cause inefficiencies and increase downtime.

Furthermore, some deployments of EIMS 602 may not include or provide for impersonation features. Such features may be used for diagnostics or troubleshooting. Where EIMS 602 and impersonation features are separated, such embodiments may also decrease efficiency and increase downtime.

The embodiments described herein provide for an EIMS 602 which leverages the benefits of multi-organization token generation and impersonation. The EIMS 602 provides seamless access to resources to authorized individuals, which increases efficiency and decreases downtime. Furthermore, by integrating such features into EIMS 602, the embodiments described herein provide for decreased computing costs by eliminating unnecessary duplication.

EIMS 602 is shown to include a processing circuit 604 including a processor 606 and/or memory 608. The processor 606 may be the same as or similar in some aspects to processor(s) 502 described above with reference to FIG. 5. Similarly, memory 608 may be the same as or similar in some aspects to memory described above with reference to FIG. 5. Hence, memory 608 may be or include volatile and/or non-volatile memory.

EIMS 602 is shown to include a communications interface 610. The communications interface 610 may provide for or enable communication between the computing environment 500 and/or client device(s) 510. Thus, the communications interface 610 may be communicably coupled to the computing environment 500 and/or client device(s) 510. The communications interface 610 may be similar in at least some aspects to communications interface(s) 508 described above with reference to FIG. 5.

The memory 608 is shown to include a token generator 612. The token generator 612 may be or include any device, component, agent, application, and so forth designed or implemented to generate a token specific for tenant(s), client device(s) 510, and/or resources 520 (collectively referred to as an entity). The token may be a data packet or structure which is uniquely associated with the particular entity. In various embodiments, the tokens may be cryptographically secured (e.g., encrypted according to various cryptographic methods and contexts). The token may be shared with the client device(s) 510, components within the computing environment 500 (e.g., via respective communications interface(s) 508, 610), and so forth.

In some embodiments, a client device 510 may be configured to request a token. In other embodiments, a tenant may be configured to request a token. In some embodiments, an application 516 (e.g., a processor 502 configured to execute the application 516) may be configured to request a token. In some embodiments, the request may include various credentials. For instance, where a client device 510 or tenant requests a token, the request may include a username, password, organization name, PIN, and/or other identifiers which may be used for authenticating a particular user/tenant. Where the application 516 requests a token (for instance, when the application is attempting to run and complete a scheduled job), the request may include a client identifier and client secret.

The token generator 612 may be configured to generate a token responsive to receiving the request. The token generator 612 may be configured to authenticate/authorize a user (e.g., using the client device 510) responsive to receiving the request from the client device 510. The token generator 612 may be configured to authenticate the user based on the username, password, organization name, PIN, etc.

The memory 608 is shown to include an EIMS database 614. The EIMS database 614 may be configured to store various information, datasets, entries, etc. for EIMS 602. EIMS database 614 may be configured to store a list of active tenants 616. The list of active tenants 616 may include a ledger of each tenant registered with EIMS 602. The tenants may enroll and/or un-enroll with EIMS 602 at various points in time. EIMS 602 may correspondingly update the list of active tenants 616. The list of active tenants 616 may also include resources 520 which are accessible by the respective tenants, by client devices 510 for each tenant, etc. As tenants are enrolled with new resources 520, the EIMS database 614 may correspondingly be updated. While shown as embodied on memory 608, in various embodiments, EIMS database 614 may be offloaded to a separate memory or storage device.

The token generator 612 may be configured to compare data stored in the EIMS database 614 with the credentials received in the request (e.g., the username, password, organization name, etc.). The token generator 612 may be configured to cross-reference the credentials with each or a subset of entries in the EIMS database 614 to identify a matching entry. The token generator 612 may be configured to authenticate the user responsive to identifying a matching entry in the EIMS database 614.

In some embodiments, the request may be made on behalf of a user of the tenant. For instance, an administrator may request a token on behalf of a user for troubleshooting, diagnostic, testing, or other purposes. In some implementations, to initiate such a request, the user would be required to provide their password to the administrator, which could increase security vulnerabilities. In some embodiments, the request may include a header. The administrator may provide (e.g., on their client device 510) an organization identifier in the header (e.g., the organization associated with the user) along with the administrator's credentials (e.g., administrator's username, password). Hence, where the request is made on behalf of another user, the request may be or include the administrator's username and password, and the organization of the user (e.g., based on the organization identifier provided by the administrator in the header). In such embodiments, the token generator 612 may be configured to authenticate the administrator's credentials. The token generator 612 may be configured to generate the token specifically for the user's organization by identifying the corresponding token for the organization identifier responsive to authenticating the credential of the administrator. The token generator 612 may copy the token from the EIMS database 614 for the particular tenant or user, identify the resources 520 which the user is permitted to access (e.g., as indicated or reflected in the EIMS database 614) and generate a token for the administrator, etc. The token generator 612 may be configured to provide the token to the client device 510 for the administrator, thus providing the administrator access to the token for the user.

In various embodiments, such as those where the request is made on behalf of a user by an administrator, the token generator 612 may be configured to generate a time-bound token. The time-bound token may be a token which is valid for a limited duration (e.g., a number of minutes, hours, days, etc.). The duration may be set by the enterprise, by the administrator, by the user, etc. The time-bound token may be active for a limited duration, and may have other security settings. For instance, the time-bound token may provide limited access to resources 520. The time-bound token may provide read-only access to the resources 520. According to such embodiments, the administrator may be configured to access resources 520 as a specific user and see resources 520 in the same manner as the specific user would see the same resources 520, though the administrator may not be permitted to modify or change any resources 520. In some embodiments, the time-bound token may provide the administrator full access to whatever resources the user is permitted to access for the limited duration. Hence, the administrator may be configured to access resource 520, see resources 520, and/or interact with resources 520 as the specific user for a limited duration.

The token generator 612 may be configured to automatically generate a token for each registered entity. The token generator 612 may be configured to identify entities as registered upon enrollment (e.g., by an enterprise administrator via a respective client device, for instance). The token generator 612 may be configured to provide the entity (e.g., via the communications interface 610) the generated token. The token may indicate which resources the entity is permitted to access.

In some embodiments, the token generator 612 may be configured to store data corresponding to the generated tokens in the entries on the EIMS database 614. For instance, where the token generator 612 generates a token for a particular client device 510, the token generator 612 may be configured to store a copy of the token (e.g., in an entry of the EIMS database 614) associated with the client device 510. The stored copy or other data corresponding to the token may be used for subsequently validating the token, as described in greater detail below.

In some embodiments, the resource 520 may be configured to request a token from the token generator 612. For instance, the processor 502 executing the application 516 may be configured to request a multi-organization token. The multi-organization token may be a resource-specific token which includes a plurality of tokens associated with various tenants. The processor 502 may request the multi-organization token responsive to the resource having a scheduled job. Various examples of jobs may include, for instance, automatic generation of reports on building functions, component usage statistics, efficiency data, employee productivity reports, etc. The processor 502 may be configured to request the multi-organization token from the token generator 612 when the processor 502 is scheduled to perform the job. As described above, the request may include the client identifier and client secret. The client identifier and client secret may be uniquely associated with a particular resource 520. The client identifier and client secret may be generated by the EIMS 602 when the resource is registered with EIMS 602 (e.g., by an administrator at enrollment).

The token generator 612 may be configured to identify the client identifier and client secret from the resource 520 (e.g., from the processor 502). The token generator 612 may be configured to cross-reference the client identifier and client secret received in the request with data included in the EIMS database 614. EIMS database 614 may be configured to store the client identifier and client secret for each resource 520 when the resource registers with EIMS 602. The token generator 612 may determine the identity of the resource 520 based on the client identifier and client secret. Responsive to validating the client identifier and client secret, the token generator 612 may be configured to identify which tenants are active for the corresponding resource 520. The tenants may be active by registering (or maintaining registration) with the resource 520, paying a renewal fee or license, etc. The token generator 612 may be configured to compile a list of tokens for the active tenants by extracting, copying, duplicating, or otherwise reproducing the tokens for the tenants which are identified as active for the corresponding resource 520. The token generator 612 may be configured to generate a multi-organization token which includes each of the tokens included in the list. Hence, the multi-organization token may include the tokens of tenants which are determined to be active with a particular resource.

The token generator 612 may be configured to provide generated token(s) to the source which requested the token. The token generator 612 may be configured to provide the token(s) through the communications interface(s) 610 to the processor 502 and/or client device(s) 510. As described in greater detail below, the tokens may be received (e.g., through a resource 520) by EIMS 602. EIMS 602 may use the tokens to determine that the token is valid and the client device 510 is permitted to access the particular resource 520.

The memory 608 is shown to include a token validator 618. The token validator 618 may be or include any device, component, agent, application, and so forth designed or implemented to validate tokens received from resource(s) 520. Generally speaking, the token validator 618 may be configured to validate the tokens received from the resource(s) 520, and determine whether the client device 510 is permitted to access the particular resource 520.

The client device 510 may be configured to provide a token to the communications interface 508 of the computing environment 500. The client device 510 may be configured to provide the token when a particular user is requesting access to a particular resource 520. In some embodiments, an administrator may provide the token on behalf of a particular user. In such embodiments, the administrator may be “impersonating” the user by providing a token which is associated with the user. In various embodiments, the client device 510 may provide the token to the communications interface 508 through an application program interface (API). The API may be or include a set of instructions or protocols which define or specify the communications structure between the client device 510 and particular resources 520. When the processor 502 determines that a token is received, the processor 502 may route the token to EIMS 602 for validation.

In some embodiments, when a resource 502 has a scheduled job, the processor 502 may communicate one of the plurality of tokens in the resource-specific token to EIMS 602. As described in greater detail below, EIMS 602 may validate the token and provide an indication that that the entity which transmitted the token is permitted to access the resource 520. The processor 502 may run the scheduled job, and communicate another token to EIMS 602. The processor 502 may iteratively communicate tokens until the processor 502 has performed all scheduled jobs for the particular resource 520.

The token validator 618 may be configured to validate the token received from the resource 520. As stated above, the EIMS database 614 may be configured to store copies or data corresponding to tokens generated by the token generator 612. The token validator 618 may be configured to cross-reference the token received from the resource 520 with entries in the EIMS database 614 to determine whether the token is valid (e.g., matches a token in the EIMS database 614, corresponds to data in the EIMS database 614, etc.). The token validator 618 may be configured to determine that the token is valid based on the cross-referencing.

The token validator 618 may be configured to determine which resources 520 correspond to the token received by the token validator 618. The token validator 618 may be configured to determine which resources the client device 510 is permitted to access based on the token. The token validator 618 may be configured to identify the entry in the EIMS database 614 which included the data used for validating the token. The entry may include resources 520 which are accessible by the entity corresponding to the token. The token validator 618 may be configured to determine whether the resource 520 which provided the token to the token validator 618 is accessible by the entity corresponding to the token. The token validator 618 may be configured to provide an indication to the resource 520 which indicates 1) whether the token is valid and 2) whether the entity corresponding to the token is permitted to access the resource 520. The processor 502 may provide (or deny) access to the resource based on the indication from the token validator 618.

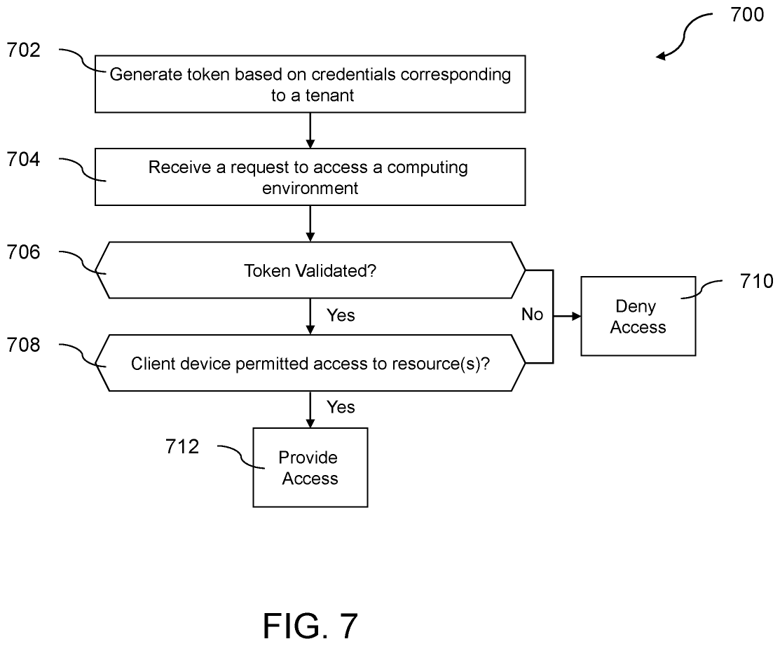

Referring now to FIG. 7, depicted is a flowchart showing a method 700 for providing access to enterprise-specific resources, according to an illustrative embodiment. The method 700 shows various steps. While shown as being arranged in a particular order, the method 700 is not limit to the particular order shown in FIG. 7. Various steps may be omitted, performed concurrently with one another, etc. While not limited to these components, the steps shown and described with reference to FIG. 7 may be practiced by the components described above with reference to FIGS. 1-6.

At step 702, the EIMS 602 generates a multi-organiziation token based on credentials corresponding to a tenant. In some embodiments, the multi-organization token is a resource-specific token corresponding to a particular resource (e.g., resource 520) of a computing environment. In some embodiments, the multi-organization token (i.e., the resource-specific token) is generated based on credentials corresponding to a particular tenant of the computing environment. The multi-organization token may be requested by a processor 502 on behalf of the particular resource when the particular resource is scheduled to provision one or more jobs for a plurality of tenants associated with the multi-organization token.

In some embodiments, the multi-organization token may include a plurality of tenant-specific tokens, including a token for the particular tenant, associated with a plurality of tenants having access to a resource. In this regard, at step 702 the EIMS 602 may also generate or retrieve a plurality of tenant-specific tokens associated with a plurality of tenants. In some embodiments, the multi-organization token may include tenant-specific tokens for the active tenants for which the resource associated with the multi-organization token is scheduled to provision jobs. As one example, a job may include the automatic generation and transmission of consumption, efficiency, etc. reports for various component(s) within the building 10.

In some embodiments, a tenant-specific token associated with the multi-organization token generated at step 702 is a time-bound token. Such a time-bound token may be generated by the EIMS 602 to limit the duration in which a particular client device 510 associated with the tenant-specific token is permitted to access various resources. The limited duration may be, for instance, a number of minutes, hours, days, etc. The duration may be set by a user, administrator, enterprise, etc. In some embodiments, the tenant-specific token may be a time-bound token to permit limited diagnostic abilities for resource(s) 520 accessible by a user.

In some embodiments, such as those where the multi-organization or resource-specific token is generated responsive to receiving a request (described in greater detail below), the EIMS 602 may be configured to cross-referencing credentials received within the request with the EIMS database 614. The request may include credentials (e.g., a username and password) and an organization identifier. In some embodiments, such as those where a particular user is accessing resource(s) 520, the credentials and organization identifier may both be for the same user. In other embodiments, such as those where an administrator generates a request on behalf of a user, the credentials may correspond to the administrator, and the organization identifier may be for the user. The EIMS 602 may generate one of the multi-organization token or the tenant-specific based in part on the organization identifier.

In some embodiments, a tenant-specific token may specify which resource(s) (e.g., resources 520) a respective client device 510, associated with a tenant (i.e., user), is permitted to access. The EIMS database 614 may include entries which indicate which resources a client device 510 or tenant is permitted to access. The EIMS 602 may identify which resource(s) each entity is permitted to access based on the entries within the EIMS database 614. The EIMS 602 may structure each tenant-specific token to specify which resource(s) 520 the entity corresponding to a given tenant-specific token is permitted to access based on the corresponding entry in the EIMS database 614.

At step 704, the EIMS 602 receives a request to access a computing environment 500. In some embodiments, the request may be received from a client device 510 corresponding to a tenant. In some embodiments, the request may be a request to access a resource 520 within the computing environment 500. The request may include a tenant-specific token and, in some embodiments, may include credentials for accessing the resource 520. In some embodiments, the request may include an organization identifier. The organization identifier may be included in a header of the request, and the body of the request may include the credentials.

In some embodiments, the request may be a request to access the computing environment 500 to provision a plurality of scheduled jobs for one or more of a plurality of tenants. The processor(s) 502 in the computing environment 500 may generate the request on behalf of resources 520 which have a plurality of scheduled jobs for provisioning. The processor(s) 502 may generate the request responsive to the job(s) being scheduled, when the jobs are scheduled for provisioning, etc. The processor(s) 502 may communicate the request via the communications interface 508 to the communications interface 610 of the EIMS 602.

In some embodiments, a tenant-specific token may be generated (e.g., as described with respect to step 702) responsive to receiving the request at step 704. For instance, where an administrator submits a request for accessing a resource 520 (or resources 520) on behalf of a tenant or user, the EIMS 602 may generate a time-bound, tenant-specific token for a first tenant specified by the administrator. As stated above, the time-bound token may limit the duration in which the administrator is permitted to access resource(s) 520 on behalf of the user. Hence, the time-bound, tenant-specific token may be a temporary token for the administrator, where the token expires after the limited duration.

At step 706, the EIMS 602 determines whether a received tenant-specific token is valid. Hence, the EIMS 602 may validate the tenant-specific token (e.g., received within the request at step 704). The EIMS 602 may validate the tenant-specific token by identifying a subset of data included in the token (e.g., within the header, within the body, etc.) which indicates that the token was generated by the EIMS 602. The EIMS 602 may validate the tenant-specific token by cross-referencing the token (or data corresponding to the token) with data included in the entries of the EIMS database 614.

In some embodiments, the EIMS 602 may determine that the tenant-specific token is valid responsive to determining that the token was generated by the EIMS 602, identifying a matching token in the EIMS database 614, identifying data in the EIMS database 614 which corresponds to the token received in the request at step 704. In some embodiments, the EIMS 602 determines that the token in valid by further determining whether the tenant-specific token is included in the multi-organization token (e.g., generated at step 702). In some such embodiments, the tenant-specific token may be determined to be valid based on an indication that the tenant-specific token is included in the multi-organization token. Where the token is valid, the method 700 proceeds to step 708. Where the token is not valid, the method 700 proceeds to step 710.

At step 708, the EIMS 602 determines whether the client device 510 is permitted to access the computing environment 500. In some embodiments, the EIMS 602 determines whether the client device 510 is permitted to access the resource 520 in the computing environment 500. In some embodiments, the EIMS determines which resources (if any) the client device 510 is permitted to access within the computing environment 500. The EIMS 602 may determine which resource(s) 520, if any, the client device 510 is permitted to access based on data included in the entries of the EIMS database 614. The EIMS database 614 may include a list of entries which includes tenants, users, client device 510, etc., and which resource(s) 520 the tenants, users, client devices 510 are permitted to access. The EIMS 602 may determine which resource(s) 520 the client device 510 is permitted to access based on the data included in the EIMS database 614.

In some embodiments, such as those where the request includes an organization identifier, the EIMS 602 may determine which resources the client device 510 is permitted to access based on the organization identifier. For instance, particular organizations (e.g., tenants, users, groups of users, etc.) may have access to various resource(s) 520. The organization identifier may indicate which organization corresponds to the request. The EIMS 602 may identify the organization based on the organization identifier. The EIMS database 614 may include data which indicates the resource(s) 520 which the client device 510 is permitted to access based on the organization identifier.

Where the client device 510 is permitted to access the resource(s) 520 within the computing environment 500, the method 700 may proceed to step 712. Where the client device 510 is not permitted to access the resource 520, the method 700 may proceed to step 710.

At step 710, the EIMS 602 denies access to the computing environment 500. The EIMS 602 may generate a notification to the requester (e.g., the client device 510, the processor 502, etc.) indicating that the client device 510 corresponding to the token is not permitted to access the particular resource.

At step 712, the EIMS 602 provides access to the permitted resource(s) 520 in the computing environment 500. In some embodiments, the EIMS 602 may provide the client device 510 access to the permitted resource(s) 520 of the computing environment. Hence, the client device 510 may be denied access to some resources 520 which the client device 510 is not permitted to access, and may be permitted access to the resources 520 which the client device 510 is permitted to access. Various examples of resource(s) 520 includes, for instance, resources 520 corresponding to faults of various components within the building 10, consumption corresponding to the component(s) of the building 10, efficiency corresponding to the component(s) of the building 10, and so forth. The resource(s) 520 may include applications 516 configured to generate reports (e.g., at scheduled intervals, referred to herein as “scheduled jobs”) corresponding to such information and statistics.

In embodiments where the request is a request to provision a plurality of scheduled jobs, providing access may include providing an indication to the processor 502 of the computing environment 500 to provide access to the resource 520 to run the plurality of scheduled jobs. The processor 502 may run the plurality of scheduled jobs. At each iteration (e.g., job), the processor 502 may transmit a new tenant-specific token corresponding to another tenant. The EIMS 602 may repeat steps 706 and 708 to determine whether the new tenant-specific token is valid and that the tenant is permitted to access the resource. The processor 502 may iteratively validate (e.g., through EIMS 602) the tenant-specific tokens and run the scheduled jobs until all scheduled jobs corresponding to the resource(s) 520 are successfully provisioned. When a new set of scheduled jobs are to be performed, the processor(s) 502 may repeat steps 702-708.

In some embodiments, the EIMS 602 may provide the client device 510 limited access to the resource(s) 520. For instance, the EIMS 602 may provide the client device 510 read-only access to the resource(s) 520. In such embodiments, the client device 510 may be associated with an administrator who submits the request on behalf of a user or tenant. The administrator may access the resource(s) 520 to identify various issues. However, the administrator may not be permitted to modify, change, etc. the resource(s) 520 or settings corresponding thereto. Hence, the administrator is provided limited access to the same resource(s) as the user. In some embodiments, such as those where the tenant-specific token is a time-bound token, the EIMS 602 may provide the client device 510 access to the resource(s) 520 for a limited duration. Once the limited duration is lapsed, the method 700 may proceed back to step 710, where the client device 510 is denied access to the resource(s) 520.

### Configuration of Illustrative Embodiments

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “illustrative” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other illustrative embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

What is claimed is:

1. A system for providing access to enterprise-specific resources, the system comprising:
a communications interface communicably coupled to a computing environment and a client device corresponding to a first tenant of a plurality of tenants of the computing environment, the computing environment including a plurality of resources, at least one resource being accessible by the client device; and
a processing circuit including a processor and memory, the memory storing instructions that, when executed by the processor, cause the processor to perform operations, the operations comprising:
generating a multi-organization token for the at least one resource based on credentials corresponding to the first tenant, wherein the multi-organization token is a resource-specific token associated with the at least one resource, and wherein the multi-organization token further includes a first tenant-specific token associated with the first tenant and a second tenant-specific token associated with a second tenant of the plurality of tenants;
receiving, from the client device, a request to access the at least one resource in the computing environment, the request including the first tenant-specific token;
determining whether the first tenant-specific token is valid, wherein a determination that the first tenant-specific token is included in the multi-organization token indicates that the first tenant-specific token is valid, and wherein the determination that the first tenant-specific token is valid further indicates that the client device is permitted to access the at least one resource in the computing environment; and
providing access to the at least one resource in the computing environment responsive to a determination that the first tenant-specific token is valid based on the indication that the first tenant-specific token is included in the multi-organization token.

2. The system of claim 1, wherein the at least one resource includes data corresponding to at least one of:
faults of one or more components of a building;
consumption corresponding to the one or more components of the building; or
efficiency corresponding to the one or more components of the building.

3. The system of claim 1, further comprising:
generating the first tenant-specific token and the second tenant-specific token responsive to receiving the request to access the at least one resource.

4. The system of claim 1, wherein the request to access the at least one resource is a request to access the computing environment to provision a plurality of scheduled jobs for the one or more tenants having access to the computing environment.

5. The system of claim 4, wherein access is provided to the at least one resource to run the plurality of scheduled jobs.

6. The system of claim 1, wherein the request includes an organization identifier.

6. tem of claim 6, wherein the operations further comprise:
determining, based on the organization identifier, which of the plurality of resources the client device is permitted to access, wherein:
access is provided to the at least one resource responsive to determining the client device is permitted to access the at least one resource.

8. The system of claim 6, wherein the request is submitted on behalf of a user of the first tenant, wherein the tenant-specific token is a time-bound token which provides the client device access to the at least one resource which the user is permitted to access for a limited duration.

9. A method of providing access to enterprise-specific resources, the method comprising:
generating, by a processing circuit, a resource-specific token based on credentials corresponding to a first tenant of a plurality of tenants, the resource-specific token associated with a first resource of a plurality of resources in a computing environment, the resource-specific token including a plurality of tenant-specific tokens including a first token for the first tenant and a second token for a second tenant;
receiving, by the processing circuit, from a client device corresponding to the first tenant, a request to access the first resource, the request including the first token;
determining, by the processing circuit, whether the first token is valid, wherein a determination that the first token is valid is based on an indication that the first token is included in the resource-specific token, and wherein the determination that the first token is valid further indicates that the first token is permitted to access the first resource; and
providing, by the processing circuit, access to the first resource in the computing environment responsive to a determination that the first token is valid.

10. The method of claim 9, further comprising:
generating the first token and the second token responsive to receiving the request to access the first resource.

11. The method of claim 9, wherein the request to access the first resource is a request to access the computing environment to provision a plurality of scheduled jobs for the plurality of tenants.

12. The method of claim 11, wherein providing, by the processing circuit, the access comprises providing, by the processing circuit, access to the first resource responsive to validating the first token to run the plurality of scheduled jobs.

13. The method of claim 9, wherein the request includes an organization identifier.

14. The method of claim 13, further comprising:
determining, by the processing circuit, based on the organization identifier, which of the plurality of resources the client device is permitted to access, wherein:
providing, by the processing circuit, access to the resources comprises providing, by the processing circuit, access to the resource responsive to determining the first resource is one of the plurality of resources the client device is permitted to access.

15. The method of claim 13, wherein the request is submitted on behalf of the first tenant, wherein the first token is a time-bound token which provides the client device access to a subset of the plurality of resources which the first tenant is permitted to access for a limited duration.

16. A building system for providing access to enterprise-specific resources, the system comprising one or more memory devices configured to store instructions thereon, that, when executed by one or more processors, cause the one or more processors to perform operations comprising:
generating a token for each of a plurality of tenants, wherein each token indicates which resources of a plurality of resources in a computing environment a corresponding tenant is permitted to access;
transmitting the tokens to a plurality of client devices associated with the plurality of tenants;
receiving, from a client device corresponding to a first tenant, a request to access one of the plurality of resources, the request including credentials for accessing the computing environment and a token corresponding to the first tenant;
determining, based on the credentials, a subset of the plurality of resources the first tenant is permitted to access within the computing environment;
validating the token based on the credentials; and
providing access to the subset of resources in the computing environment responsive to validating the token.

17. The system of claim 16, wherein the request is submitted on behalf of a user of the tenant, and wherein a first token of the tokens for each of a plurality of tenants is a time-bound token.

18. The system of claim 17, wherein providing access to the subset of resources comprises providing, to the client device, read-only access to the subset of resources on behalf of the client for a limited duration of time in accordance with the time-bound token.

19. The system of claim 16, wherein the request is a request to access the computing environment to provision a plurality of scheduled jobs for one or more of the plurality of tenants having access to the computing environment.

20. The system of claim 19, wherein providing access comprises providing access to the subset of resources responsive to validating the token to run the plurality of scheduled jobs.
